(19) United States
(12) Patent Application Publication
(10) Pub. No.: US 2018/0169539 A1
(43) Pub. Date: Jun. 21, 2018

(54) UNIT FOR CONNECTING PARTS

(71) Applicants: Vitalijs KOZUJEVS, St. Petersburg (RU); Evgeny Yurievich GREKOV, St. Petersburgh (RU)

(72) Inventors: Vitalijs KOZUJEVS, St. Petersburg (RU); Evgeny Yurievich GREKOV, St. Petersburg (RU)

(21) Appl. No.: 14/786,523

(22) PCT Filed: Feb. 28, 2014
(86) PCT No.: PCT/RU2014/000131

§ 371 Date: Dec. 14, 2015

(30) Foreign Application Priority Data
Apr. 29, 2013 (RU) 2013120019

(51) Int. Cl. A63H 33/08; F16B 5/07; F16B 3/04; F16B 5/00; F16B 17/00; F16B 5/12

(52) U.S. Cl. CPC A63H 33/082; F16B 5/07; F16B 3/04; A47B 2230/0077; F16B 17/008; F16B 5/126; F16B 5/008

(57) ABSTRACT

The invention relates to detachable connections for pieces, mainly rigid ones, and can be used, in particular, for connecting elements of building constructions, for example, transparent domes, equipment frame bodies, furniture and toy elements etc. In the joint for connecting pieces having a curved surface, which comprises projections arranged on mated sides of the pieces, said projections having bulbous widenings at their ends and necks at their bases, and complementary grooves in the form of bulbous cavities that correspond to the bulbous widenings of the projections and change into narrow channels that match the necks of the projections, and wherein the surfaces of the ends of the projections and the surfaces of the bottom of the grooves mated thereto have conical shape, and the tips of the surfaces of the ends of projections and the bottom of the cavities are arranged on opposite sides relative to the connected pieces, the side surfaces of the projections and the side surfaces of the grooves mated thereto are formed by moving a straight line along the guide path, which is the intersection line of the spherical surface with the cylindric surface formed by moving a straight line along an S-shaped guide path, and wherein the side surfaces of the projections and the side surfaces of the grooves are smoothly mated with the surfaces of the ends of projections and the surfaces of the bottom of the grooves, respectively. A joint for connecting pieces delimited by curved surfaces is created.

### TECHNICAL FIELD

The invention relates to detachable connections for pieces, mainly rigid ones, and can be used, in particular, for connecting elements of building constructions, for example, transparent domes, equipment frame bodies, furniture and toy elements etc.

### BACKGROUND ART

A known connection of type “tongue-and-groove” is known from RU 2063158 C1. This structure is used for connecting end surfaces of planks that are mated with each other by the longitudinal sides thereof with a transverse rail, wherein the means for connecting planks with each other and with the rail is formed by interworking grooves and projections having dovetail-shaped shoulders, the shoulders being sloped relative to the plane that is perpendicular to the base plane of the planks, with the slope being directed towards the edges of the projection and the groove.

The disadvantages of this technical solution consist in that such joint can only be used for connecting narrow planks with a rail; whereas the connection of wide plates is virtually impossible, because it is extremely difficult to prevent locking of the plates during their alignment; in addition, the joint is weak in bending due to the concentration of stress in the bending points.

A known joint for connecting flat pieces comprises interlocking complementary dovetail-shaped sockets and projections that are arranged on the end sections of butted pieces, see SU 1624218 A1; longitudinal slots are provided at the base of each projection of one of the connected pieces, the mated side surfaces of the projections and sockets are made with alternating combination of the inclination directions, wherein the inter-facing side surfaces of two adjacent projections have identical direction of inclination, the end surfaces of the projections of one of the pieces are arranged with alternating direction of inclination, and the end surfaces of the projections of the complementary piece are rounded.

This connection can only be used for connecting elements, of which at least one (piece 1) must be resilient and made of sufficiently elastic materials such as rubber or soft plastics; this is due to the fact that the projections of piece 1 must bend off during the assembly and assume a position under high angle to the surface of this piece; making both pieces out of a rigid material prevents their connection, which can be done only by forcing apart the projections 5 by means of projections 4; if projections 3 are made rigid, they will not bend off; if they are made elastic but not resilient, they will not return to the required position. Thus, this connection joint does not provide sufficient mechanical strength of the connection, because it is essentially not suited for connecting rigid pieces.

Another known joint for connecting flat rigid pieces comprises projections arranged on mated sides of the pieces, said projections having bulbous widenings at their ends and necks at their bases, and complementary grooves in the form of bulbous cavities that change into narrow channels that correspond to the necks of the projections; the surfaces of the ends of the projections and the mated surfaces of the bottom of the grooves have cylindrical shape, see U.S. Pat. No. 5,588,240 A.

This joint allows connecting pieces of any rigidity, including absolutely rigid pieces, in particular, pieces made of hard metals, minerals and similar materials.

This technical solution provides reliable connection of pieces while working in tension. However, it is not suitable for work in bending, as well as for displacement in the direction perpendicular to the plane of the connected pieces. Therefore in practice this connection joint is only used for various toys and games.

Another known joint for connecting flat rigid pieces comprises projections arranged on mated sides of the pieces, said projections having bulbous widenings at their ends and necks at their bases, and complementary grooves in the form of bulbous cavities that correspond to the bulbous widenings of the projections and change into narrow channels that match the necks of the projections; the surfaces of the ends of the projections and the surfaces of the bottom of the grooves mated thereto have conical shape, and wherein the tips of the conical surfaces of the ends of projections and the bottom of the cavities are arranged on opposite sides relative to the connected pieces; the curvature radii of the guide paths of the conical surfaces of the ends of projections and the bottom of cavities can be arranged as approaching infinity; at least one of the connected pieces can be composite, thickness-wise, see RU 2263829 C2.

This technical solution has been taken as a prototype of the present invention.

The disadvantage of the prototype consists in the fact that it allows connecting only flat pieces, whereas there is an immediate need for connecting pieces delimited by curved surfaces, for example, spherical or elliptic surfaces, etc.

### SUMMARY OF THE INVENTION

It is an object of the present invention to provide a joint for connecting pieces that are delimited by curved surfaces.

According to the invention in the joint for connecting pieces, which comprises projections arranged on mated sides of the pieces, said projections having bulbous widenings at their ends and necks at their bases, and complementary grooves in the form of bulbous cavities that correspond to the bulbous widenings of the projections and change into narrow channels that match the necks of the projections, and wherein the surfaces of the ends of the projections and the surfaces of the bottom of the grooves mated thereto have conical shape, and the tips of the surfaces of the ends of projections and the bottom of the cavities are arranged on opposite sides relative to the connected pieces, the side surfaces of the projections and the side surfaces of the grooves mated thereto are formed by moving a straight line along the guide path, which is the intersection line of the spherical surface with the cylindric surface formed by moving a straight line along an S-shaped guide path, and wherein the side surfaces of the projections and the side surfaces of the grooves are smoothly mated with the surfaces of the ends of projections and the surfaces of the bottom of the grooves, respectively.

The applicant has not found any technical solutions identical to the present invention, which enables to conclude that the invention conforms to the patentability criterion “Novelty” (N).

Implementation of the features of the invention provides the object with an important new property (technical result), which consists in ensuring reliable connection of pieces having curved shape.

The applicant has not found any sources of information containing data on the influence of the features of the invention on the technical result produced by the invention. In applicant's opinion, the abovementioned new properties of the object enable to conclude that the invention conforms to the patentability criterion “Inventive Step” (IS).

### BRIEF DESCRIPTION OF THE DRAWINGS

The essence of the invention is further explained by way of example with reference to the following drawings, in which:

FIG. 1 shows connected fragments of pieces, plan view;

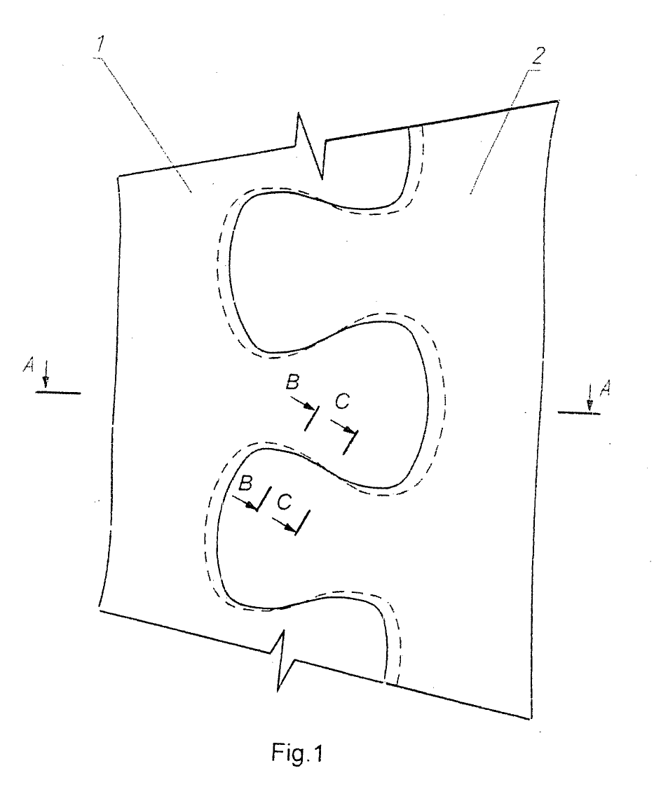

FIG. 2 shows fragments of pieces in disconnected position;

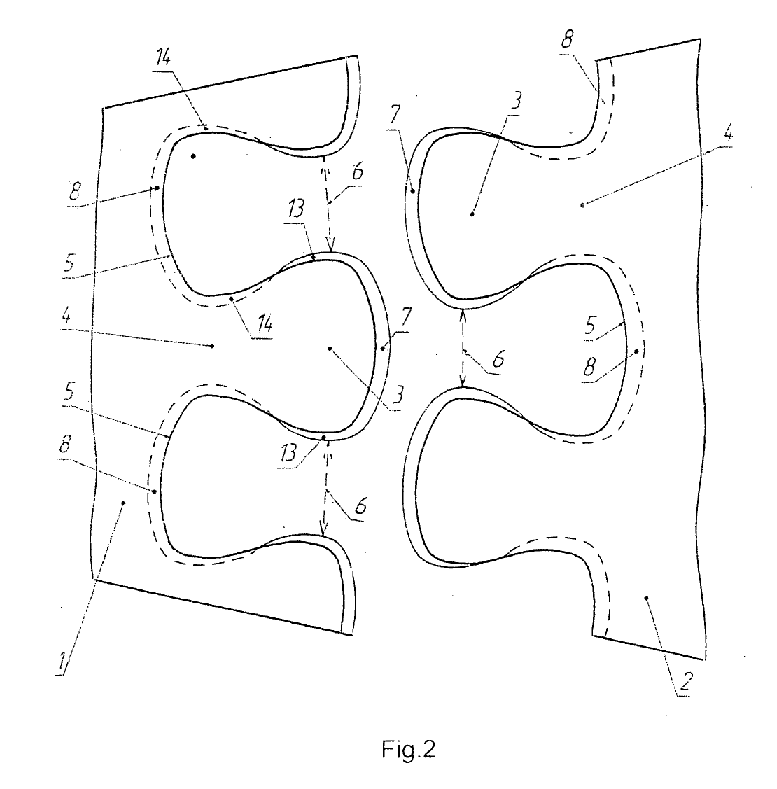

FIG. 3 shows A-A section of FIG. 1;

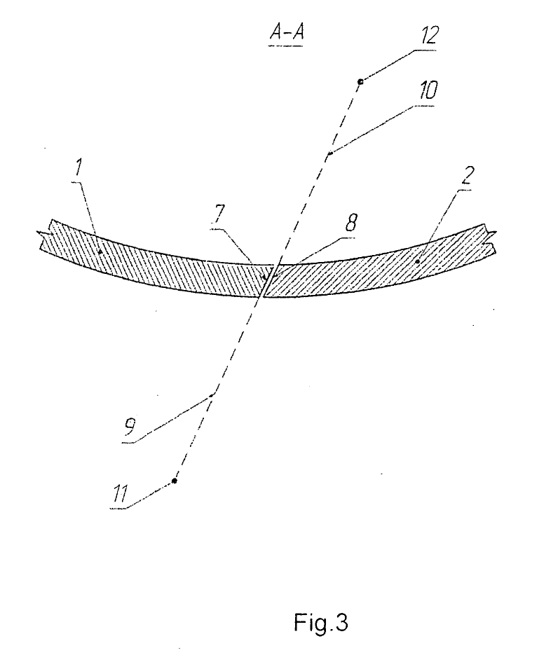

FIG. 4 shows B-B ( [symbol] ) section of FIG. 1;

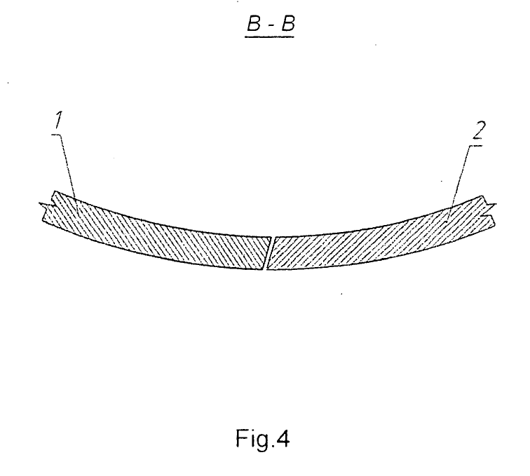

FIG. 5 shows C-C (B-B) section of FIG. 1;

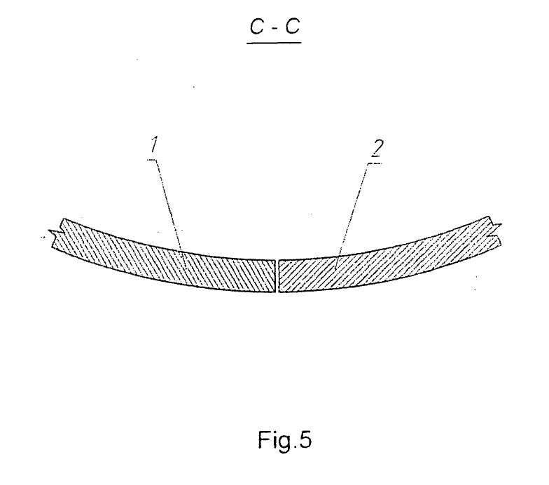

FIG. 6 shows the guide path along which moves a straight line when forming the side surfaces of the projections and the grooves;

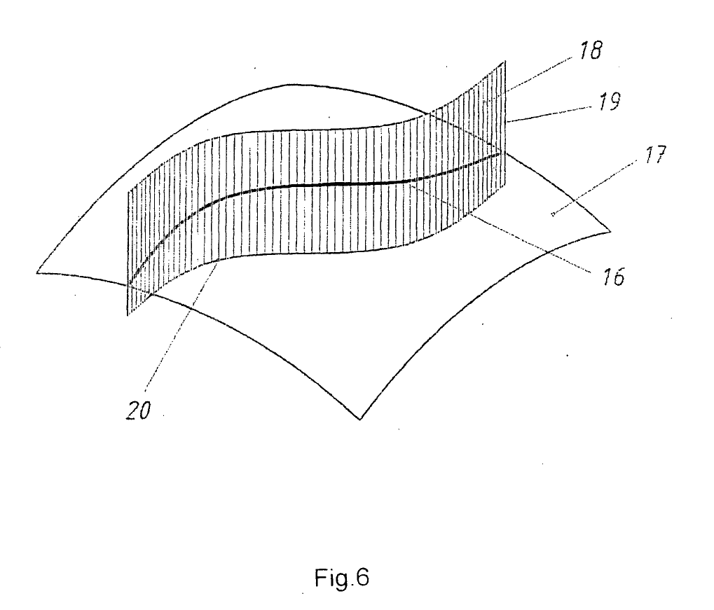

FIG. 7 shows the side surface of the projections and the cavities, which is formed by a straight line moving along the guide path, which is the intersection line of the spherical surface with the cylindric surface formed by moving a straight line along an S-shaped guide path;

FIG. 8 shows pieces in the process of connection thereof (axonometric projection);

FIG. 9 shows connected pieces (axonometric projection).

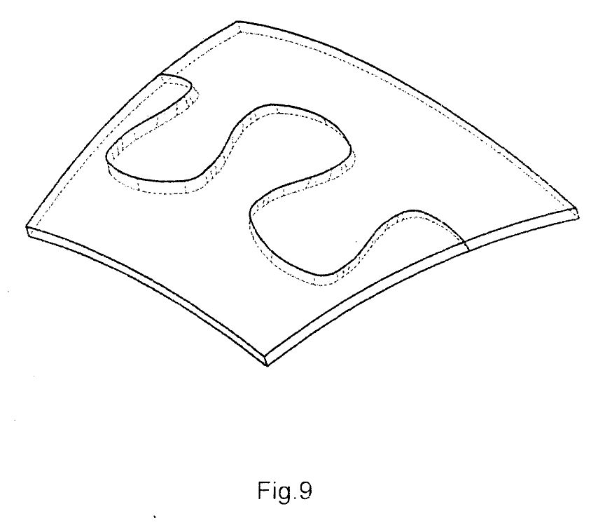

### PREFERRED EMBODIMENT

A joint for connecting pieces 1 and 2 having a curved surface, in this particular example a spherical surface, comprises projections arranged on mated sides of the pieces, said projections having bulbous widenings 3 at their ends and necks 4 at their bases, and complementary grooves in the form of bulbous cavities 5 that correspond to the bulbous widenings 3 of the projections and change into narrow channels 6 that match the necks 4 of the projections. The surfaces 7 of the ends of the projections and the surfaces 8 of the bottom of the grooves mated thereto have conical shape. The guide path 9 of the conical surface 7 passes through the tip 11, and the guide path 10 of the conical surface 8 passes through the tip 12, the tips 11 and 12 being arranged on opposite sides relative to the connected pieces.

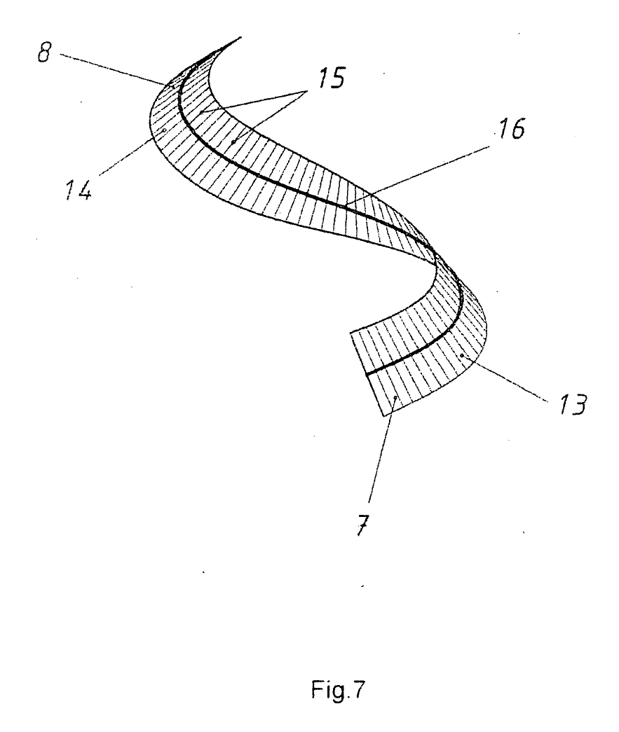

The side surfaces 13 of the projections and the side surfaces 14 of the grooves mated thereto are formed by moving the segments 15 of a straight line along the guide path 16 (see FIG. 7). The guide path 16 is the intersection line of the spherical surface 17 with the cylindric surface 18. The side surfaces 13 of the projections are smoothly mated with the surfaces 7 of the ends of projections, and the side surfaces 14 of the grooves are smoothly mated with the surfaces 8 of the bottom of the grooves.

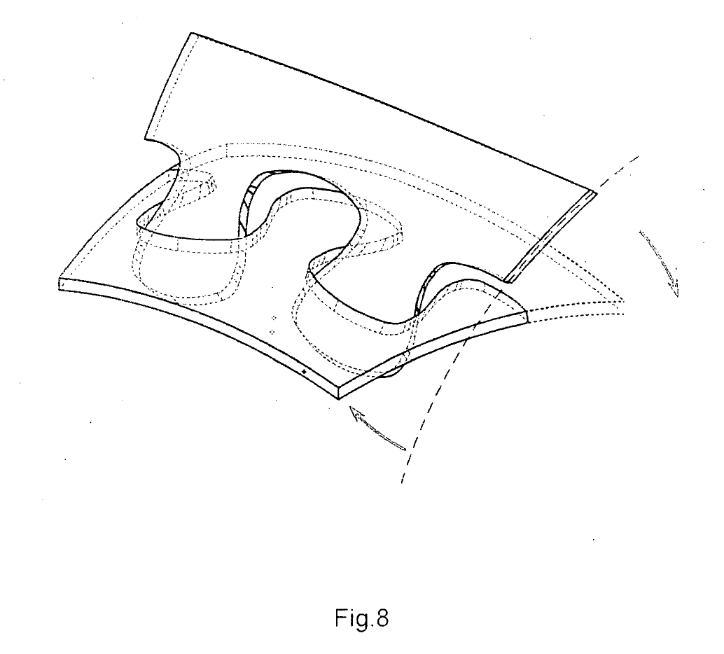

Pieces 1 and 2 are connected in the following way. The pieces are first aligned at an angle to each other (see FIG. 8), with the bulbous widenings 3 of piece 2 entering the bulbous cavities 5 of piece 1; then the pieces 1 and 2 are turned relative to each other, with the widenings 3 being placed inside the cavities 5. Correspondingly, the necks 4 of the projections of each piece are placed inside the narrow channels 6 of the other piece. The mutual rotation of the pieces 1 and 2 ceases when the surfaces of the widenings 3 run into the surfaces of the cavities 5. A rigid composite casing is formed, which works in compression/tension and in shear in virtually the same way as a solid casing; the assembled construction works in bending only in one direction, i.e. when the bending moment has the same direction as the direction of rotation of the pieces during the assembly thereof. The construction is disassembled in reverse order.

### INDUSTRIAL APPLICABILITY

The invention can be manufactured by means of common construction materials and factory equipment. In applicant's opinion, this enables to conclude that the invention conforms to the criterion “Industrial Applicability” (IA).

1. A joint for connecting pieces 1,2, which comprises projections arranged on mated sides of the pieces, said projections having bulbous widenings 3 at their ends and necks 4 at their bases, and complementary grooves in the form of bulbous cavities 5 that correspond to the bulbous widenings 3 of the projections and change into narrow channels 6 that match the necks 4 of the projections, and wherein the surfaces 7 of the ends of the projections and the surfaces 8 of the bottom of the grooves mated thereto have conical shape, and the tips 11,12 of the surfaces 7 of the ends of projections and the surfaces 8 of the bottom of the cavities are arranged on opposite sides relative to the connected pieces 1,2, characterized in that the side surfaces 13 of the projections and the side surfaces 14 of the grooves mated thereto are formed by moving a straight line 15 along the guide path 16, which is the intersection line of the spherical surface 17 with the cylindric surface 18 formed by moving a straight line 19 along an S-shaped guide path 20, and wherein the side surfaces 13 of the projections and the side surfaces 14 of the grooves are smoothly mated with the surfaces 7 of the ends of projections and the surfaces 8 of the bottom of the grooves, respectively.
